(19) United States
(12) Patent Application Publication
(10) Pub. No.: US 2006/0128906 A1
(43) Pub. Date: Jun. 15, 2006

(54) Process for preparing a polyester resin

(75) Inventors: Robin Winters, Bemmel (NL); Siebe Cornelis De Vos, Arnhem (NL); Rudolf Anthonius Maria Venderbosch, Duiven (NL); Johannes Adrianus Pardoen, Halsteren (NL)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/301,837

(22) Filed: Dec. 13, 2005

Related U.S. Application Data
(60) Provisional application No. 60/635,497, filed on Dec. 13, 2004.

(51) Int. Cl. C08L 67/00; C08F 20/00; G03G 9/00; G03G 16/00

(52) U.S. Cl. 525/437; 525/540; 430/105

(57) ABSTRACT

The present invention relates to a process for preparing a polyester resin having a gel content of less than 0.45 wt %, based on the total weight of the polyester resin, and a glass transition temperature of between 40 and 70° C., comprising the step of reacting a polyester resin precursor with a chain extender which is different from the building blocks of the polyester precursor resin, optionally in the presence of a catalyst, at a temperature between 170 and 300° C. in a continuous reactor, wherein the polyester resin precursor comprises a functional group present as end group selected from hydroxyl or carboxyl, and optionally a functional group in the polyester resin precursor backbone selected from hydroxyl, carboxyl, amine, and carbonate, and the molar ratio of the functional group in the polyester resin precursor backbone to the functional group present as end group is at most 10:1. The invention further pertains to a polyester resin having a gel content of less than 0.45 wt %, based on the total weight of the polyester resin, and a glass transition temperature of between 40 and 70° C., which is prepared from a polyester resin precursor and a chain extender which is different from the building blocks of the polyester precursor resin.

This application claims priority based on U.S. Provisional Patent Application No. 60/635,497, filed Dec. 13, 2004.

The present invention relates to a process for preparing a polyester resin in a continuous reactor, for example using reactive extrusion. The invention further relates to a polyester resin.

### BACKGROUND OF THE INVENTION

Polyester resin can be prepared by using reactive extrusion.

U.S. Pat. No. 5,486,444 describes a process of for the preparation of cross-linked polyester wherein a polyhydroxy-functional polyester resin precursor is reacted with a dianhydride or diepoxy-functional cross-linking component. In particular, a poly(1,2-propylene 1,3-butylene pentaerythritol terephthalate) polymer is dry-blended with pyromellitic dianhydride or mixture of dianhydrides, such as 3,3′,4,4′-benzophenone tetracarboxylic dianhydride, and reacted in an extruder to form a cross-linked polymer with 0.5 to 35 percent gel.

EP 0 617 337 relates to a toner comprising a binder resin comprising a phenolic hydroxyl group-containing polyester resin and a colorant. This document discloses the preparation of a polyester from 2,2-bis[4-(2-hydroxyethyleneoxy) phenyl]propane (1 mol), dimethyl isophthalate (0.5 mol), and dimethyl 5-hydroxy isophthalate (0.5 mol). The obtained polyester is subsequently mixed with a bisphenol A-type epoxy compound and melt-kneaded with a twin-screw kneader at 180° C. for 1 hour.

With previously disclosed processes the art polyester resins are obtained which contain gel (i.e. cross-linked product). If such gel-containing polyester resins are used in a toner, these resins may hinder the dispersion of pigments, which in turn may lead to the production of pigment-rich and pigment-less toner particles. In addition, these polyester resins cause the toner particles to have poor flowing properties under fusing conditions, which results in an increase of the minimum fusing temperature of the toner.

### SUMMARY OF THE INVENTION

It is an object of the present invention to provide a process for preparing a polyester resin in a continuous reactor wherein the obtained polyester resin has an increased weight average molecular weight (Mw) and simultaneously a low amount of cross-linked product.

### DETAILED DESCRIPTION OF THE INVENTION

This object is achieved by a process for preparing a polyester resin having a gel content of less than 0.45 wt %, based on the total weight of the polyester resin, and a glass transition temperature of between 40 and 70° C., comprising the step of reacting a polyester resin precursor with a chain extender which is different from the building blocks of the polyester precursor resin, optionally in the presence of a catalyst, at a temperature between 170 and 300° C. in a continuous reactor, wherein the polyester resin precursor comprises a functional group present as end group selected from hydroxyl or carboxyl, and optionally a functional group in the polyester resin precursor backbone selected from hydroxyl, carboxyl, amine, and carbonate, and wherein the molar ratio of the functional group in the polyester resin precursor backbone to the functional group present as end group is at most 10:1.

By using the process of the invention a polyester resin with increased Mw can be obtained. The Mw of the product can be twice as high as the initial Mw of the polyester resin precursor, or the Mw can be increased by even more than a factor two. Simultaneously, the amount of cross-linked product is considerably reduced, for instance to a gel content of less than 0.45 wt %, based on the total weight of the obtained polyester resin. Such gel particles may even be absent. With the process of the invention the polyester resin can be produced continuously at relatively high speed. The residence time in the continuous reactor generally is at most 20 minutes, preferably at most 10 minutes, and most preferably at most 5 minutes.

A further advantage is that the produced polyester resin can be produced more consistently in terms of physical and chemical properties than polyester resins produced by polycondensation of the respective monomers in a batch process. Additionally, with the process of the invention polyester resins can be obtained which have a higher viscosity than those obtained using conventional batch processes. The polyester resin obtainable by the process of the invention is particularly suitable as toner resin.

The polyester resin precursor suitable for use in the process of the invention may be any conventional polyester resin known to the man skilled in the art. The polyester resin precursor is suitably prepared from monomers having two or more substituted or unsubstituted carboxylic acid moieties, such as diacids, diesters and/or anhydrides and substituted acids, and monomers having two or more hydroxyl groups, such as diols including glycols, and polyols. The polyester may further be prepared from monomers comprising an amine and/or a carbonate. It is preferred, however, that the amount of monomers comprising amine and/or carbonate is low compared to the monomers having two or more hydroxyl groups and the monomers having two or more carboxylic acid moieties. The amine and/or carbonate-containing monomers preferably constitute less than 20 mole %, more preferably less than 10 mole %, and most preferably less than 5 mole % of all monomers used in the polyester resin precursor.

Particularly preferred for the process of the present invention are polyester resin precursors predominantly prepared from a diacid and/or anhydrides thereof and a diol. By the term “predominantly” is meant that use is made of a relatively small amount of monomer to introduce a reactive group selected from hydroxyl, carboxylic acid, amine or carbonate in the polyester resin backbone, such as a triol and a triacid for example, so as to obtain a polyester resin having a molar ratio of the reactive group in the polyester resin precursor backbone to the functional group present as end group of at most 10:1.

Preferably, the molar ratio of the functional group in the polyester resin precursor backbone to the functional group present as end group is at most 5:1, more preferably at most 2:1, and most preferably at most 1:1. In a further preferred embodiment of the invention, a polyester resin precursor is used in the process of the invention which does not contain a functional group in the polyester resin precursor backbone. It is noted that in the context of this application the term “backbone” refers to the longest polyester chain of the polyester resin precursor, rendering it possible that the longest chain comprises polyester side-groups of half the size of the backbone.

Examples of diacids and/or anhydrides are malonic acid, succinic acid, 2-methylsuccinic acid, 2,3-dimethylsuccinic acid, dodecylsuccinic acid, glutaric acid, adipic acid, 2-methyladipic acid, pimelic acid, azelaic acid, sebacic acid, terephthalic acid, isophthalic acid, phthalic acid, 1,2-cyclohexanedioic acid, 1,3-cyclohexanedioic acid, 1,4-cyclohexanedioic acid, glutaric anhydride, succinic anhydride, dodecylsuccinic anhydride, maleic anhydride, fumaric acid, maleic acid, itaconic acid, 2-methylitaconic acid, dialkyl esters, wherein the alkyl groups are the same or different and comprise 1 to 23 carbon atoms and are esters of malonate, succinate, 2-methyl succinate 2,3-dimethylsuccinate, dodecylsuccinate, glutarate, adipic acid, 2-methyladipate, pimelate, azelate, sebacate acid, terephthalate, isophthalate, phthalate, 1,2-cyclohexanedioate, 1,3-cyclohexanedioate, 1,4-cyclohexanedioate, and mixtures thereof.

Examples of diols are ethylene glycol, 1,2-propylene glycol, 1,3-propylene glycol, 1,2-butylene glycol, 1,3-butylene glycol, 1,4-butylene glycol, 1,2-pentylene glycol, 1,3-pentylene glycol, 1,4-pentylene glycol, 1,5-pentylene glycol, 1,2-hexylene glycol, 1,3-hexylene glycol, 1,4-hexylene glycol, 1,5-hexylene glycol, 1,6-hexylene glycol, heptylene glycols, octylene glycols, decalyne glycol, dodecalyne glycol, 2,2-dimethyl propanediol, propoxylated bisphenol A, ethoxylated bisphenol A, 1,4-cyclohexane diol, 1,3-cyclohexane diol, 1,2-cyclohexane diol, 1,2-cyclohexane-dimethanol, 2-propane diol, mixtures thereof.

Generally, the glass transition temperature of the polyester resin precursor is between 40 and 70° C., preferably between 45 and 65° C., and most preferably between 50 and 60° C.

It is noted that the term “the glass transition temperature of the polyester resin precursor” includes the glass transition temperature of blends of polyester resins and glass transition temperature lowering compounds, such as plasticizers. The glass transition temperature is generally measured using differential scanning calorimetry (DSC) with a heating and cooling rate of 10° C./min.

It is less preferred to prepare a polyester resin with the process of the invention having a melting point above 150° C., such as poly-ethyleneterephtalate (PET) or poly-butyleneterephtalate (PBT). These polyester resins are not suitable as toner resin because the melting points are too high to ensure good quality of copies and prints in conventional copiers an printers.

The chain extender suitable for the process of the present invention has at least two reactive groups capable of reacting with the functional group of the polyester resin precursor. Preferably, the chain extender comprises at most three reactive groups, and most preferably the chain extender comprises two reactive groups.

The reactive groups of the chain extender are capable of reacting with the end group of the polyester resin precursor and optionally capable of reacting with the functional group present in the backbone of the polyester resin precursor. Examples of chain extenders are epoxides, such as Epikote™ 828LV ex Resolution™, anhydrides such as 1,2,4,5-benzene tetracarboxylic dianhydride, hexahydrophthalic anhydride, succinic anhydride, oxazolines, carbonyl biscaprolactam, or mixtures thereof. Preferably, the chain extender is a diepoxide or a dianhydride, or mixtures thereof. Diisocyanates (e.g. toluenediisocyanate or 1,6-hexamethylenediisocyanate) are less preferred because of the fact that the urethane bond is not stable under the preferred reaction temperatures of 170-300° C.

Generally, the amount of chain extender is at least 0.005 percent by weight (wt %), preferably at least 0.01 wt %, and most preferably at least 0.05 wt %, and at most 15 wt %, preferably at most 12 wt %, and most preferably at most 10 wt %, based on the total weight of polyester resin precursor.

Preferably, a catalyst is used in the process of the invention. Catalysts suitable for the process of the invention generally are catalysts known in the art. Examples of such catalysts are tetraalkyl titanates such as tetraorthobutyl titanate, dialkyltin oxide, dialkyltin oxide hydroxide, aluminium alkoxides, zinc oxide, stannous oxide, dibutyltin oxide, butyltin oxide hydroxide, tetraalkyl tin, such as dibutyltin dilaurate, calcium phosphonate, lithium chloride, zinc acetate dehydrate, zinc undecylenate, calcium acetate monohydrate, metallic soaps such as iron and zinc soaps, such as Nuodex ZN12 ex Sasol, and mixtures thereof. Preferably, the catalyst is a metallic soap, more preferably the catalyst is a zinc soap.

Generally, the amount of catalyst is at least 0.001 wt %, preferably at least 0.005 wt %, and most preferably at least 0.01 wt %, and at most 10 wt %, preferably at most 8 wt %, and most preferably at most 5 wt %, based on the total weight of polyester resin precursor.

The continuous reactor can be any reactor known to the man skilled in the art that allows the continuous production of a polyester resin in accordance with the invention. Suitable continuous reactors include tube reactors, extruders such as (co-rotating) twin- or single-screw extruders, plow mixers, compounding machines, and other suitable high-intensity mixers. Preferably, the continuous reactor is an extruder. The continuous reactor may be equipped with a vacuum pump for creating a reduced pressure in the reactor so that gases evolving during the reaction can be removed.

The temperature at which the reaction is to take place in the extruder preferably is above the glass transition temperature and below the temperature at which decomposition of the polyester resin precursor takes place. Preferably, this temperature is at least 170° C., preferably at least 180° C., and most preferably at least 185° C., and at most 310° C., preferably at most 300° C., and most preferably at most 295° C. When present in the extruder during the process of the invention, a mixture of the molten polyester resin precursor, the chain extender, and optionally a catalyst is heated to the desired temperature at which the reaction takes place for at least a certain period of time. The mixture may be exposed to one temperature or to a plurality of temperatures when present in the extruder.

It is also envisaged to add to the reaction mixture additives which are conventionally used in toners, such as pigments, dyes, and polymers. In this way, the toner composition can be obtained in one step by the process of the invention. The additives and the polyester resin are homogeneously distributed throughout the toner composition. Subsequent to the extrusion step the toner composition is processed to form toner particles in any desired shape using conventional methods known to the man skilled in the art.

The invention further relates to a polyester resin obtainable by the process of the invention. The polyester resin having a gel content of less than 0.45 wt %, based on the total weight of the polyester resin, and a glass transition temperature of between 40 and 70° C. is preferably prepared from a polyester resin precursor and a chain extender which is different from the building blocks of the polyester precursor resin.

Preferably, the polyester resin precursor comprises a functional group selected from hydroxyl or carboxyl, and optionally a reactive group selected from hydroxyl, carboxyl, amine, and carbonate; and the molar ratio of the reactive group in the polyester resin precursor backbone to the functional group present as end group is at most 10:1. Preferably, the molar ratio of the functional group in the polyester resin precursor backbone to the functional group present as end group is at most 5:1, more preferably at most 2:1, and most preferably at most 1:1. In a further preferred embodiment of the invention, a polyester resin precursor which does not contain the functional group in the polyester resin precursor backbone is used in the process of the invention. In another preferred embodiment, the polyester resin has a melt viscosity of at least 2.5 Pa·s at 240° C., preferably at least 3 Pa·s at 240° C., and most preferably at least 3.5 Pa·s at 240° C. The melt viscosity is determined using a TA rheometer with a cone and plate geometry at a shear rate of 100 s⁻¹.

The polyester resin of the invention furthermore has a low gel content, i.e. a small amount of cross-linked product. Generally, the gel content is at most 0.45 wt %, preferably at most 0.3 wt %, even more preferably at most 0.1 wt %, based on the total weight of the obtained polyester resin, and most preferably the polyester resin does not comprise any gel. The gel content can be determined using the method described in U.S. Pat. No. 5,486,444. The low gel content of the polyester resin causes a toner comprising the polyester resin to have good flow properties when applied to a substrate.

Generally, the Mw of the polyester resin is higher than the Mw of the polyester resin precursor. Preferably, the Mw is at least 6 kg/mol, more preferably the Mw is at least 10 kg/mol, and most preferably at least 20 kg/mol.

An advantage of the process of the invention is that a polyester resin can be produced consistently in terms of its chemical and physical properties. This means that the polyester resin can be reproducibly produced if the process conditions, such as the dosing rate, reaction temperature, and mixing conditions, are controlled sufficiently. Sufficient process control is within the knowledge of the skilled person. The process of the invention also allows a narrow distribution of molecular weights in the final product, which can be expressed by the polydispersity index, i.e. the ratio of the weight average molecular weight to the number average molecular weight. The polydispersity index of the polyester resin obtained with the process of the invention preferably is at most 10, more preferably at most 8, and most preferably at most 5.

Typically, the polyester resin obtained with said process generally has a glass transition temperature that is the same or differs slightly (i.e. a difference in glass transition temperature of up to 5° C.) from the glass transition temperature of the polyester resin precursor.

Generally, the glass transition temperature of the polyester resin is between 40 and 70° C., preferably between 45 and 65° C., and most preferably between 50 and 60° C.

In a further embodiment of the present invention, the polyester resin precursor is mixed with a second polyester resin precursor. The second polyester resin is different from the polyester resin precursor according to the invention and described above. The second polyester resin precursor may comprise different monomers or it may comprise the same monomers, and it may further be substantially linear or branched. The second polyester resin precursor can be mixed before, simultaneously with, or after the polyester resin precursor of the invention is mixed with the chain extender. It is also contemplated to mix the polyester resin precursor with one or more other polyester resin precursors. By using a mixture of the polyester resin precursor of the invention and a second polymer precursor in the process of the invention, a block copolymer is obtained wherein each of the polyester resin precursor and the second polymer precursor forms a block which is connected to the next block via the chain extender. The physical properties of the product obtained can be tuned by choosing the appropriate polymers and reaction conditions. For example, a product can be provided which has only amorphous blocks, and also a product having crystalline and amorphous blocks, e.g. a semi-crystalline block copolymer, can be obtained. In this way block copolymers of polyester resins having different glass transition temperatures may be obtained, so that the glass transition temperature of the resulting block copolymer can be tuned within the range of 40 to 70° C. Additionally or alternatively, if it comprises crystalline blocks, the block copolymer may also have a melting point. By adjusting the chemical and/or physical properties of the block copolymer, the powder stability of a toner may be increased. Preferably, the polyester resin precursors forming the block copolymer of the invention are miscible.

The polyester resins and the block copolymers of the invention can be advantageously used in toner formulations. They are particularly suitable for use in toners comprising colour pigments. A good dispersion of pigments in the toner particles can be obtained when using the polyester resin. The toner particles exhibit good flowing properties at fusing conditions, which is particularly advantageous for toners comprising colour pigments.

In the Examples below a polyester resin precursor A and a polyester resin precursor B were used for chain extension with Epikote 828LV, ex Resolution™, which is a liquid epoxy resin. Polyester resin precursor A is obtained from the monomers isophthalic acid, adipic acid, and propoxylated bisphenol A and has a glass transition temperature of 53° C. as measured with DSC at a cooling and heating rate of 10° C./min. Polyester resin precursor B is obtained from the monomers terephthalic acid, adipic acid, and ethoxylated bisphenol A and has a glass transition temperature of 57° C. as measured with DSC at a cooling and heating rate of 1° C./min. The catalyst used in the chain extension reaction is Nuodex™ Zn12 (ex Sasol).

### EXAMPLE 1

A co-rotating twin-screw extruder (Berstorff ZE25A x 48UTS-UG) was equipped with a loss-in-weight feeder from K-Tron. The extruder was set at a screw speed of 200 rpm and a temperature in the reaction zone of 250° C. The polyester resin precursor A, was fed at a rate of 2 kg/h, and the Epikote 828LV (5 wt % based on the polyester resin) was pumped into the extruder (at L/D of 8) using a gear pump. Before addition, the chain extender was premixed with a fixed amount of catalyst Nuodex Zn12 at such a level that the concentration was 1 wt %, based on the unmodified polyester resin precursor.

### EXAMPLE 2

The chain extension reaction was performed under the same conditions as described under Example 1, except that 8 wt % of Epikote 828LV was used.

The polyester resins obtained in Examples 1 and 2 were analyzed using size exclusion chromatography (SEC) with polystyrene calibration in order to determine the molecular weight data of the chain extended polyester resin. The results are shown in Table 1.

TABLE 1

| | Amount of | | | |
|---|---|---|---|---|
| | Chain extender | Mₙ | M_{w} | |
| No. | wt % | (g/mol) | (g/mol) | M_{w}/Mₙ |
| A | None | 3300 | 7410 | 2.24 |
| Exp. 1 | 5 | 6188 | 20700 | 3.38 |
| Exp. 2 | 8 | 6830 | 25000 | 3.66 |

From Table 1 it can be deduced that the polyester resins of Examples 1 and 2, which are in accordance with the present invention, have increased Mₙ and M_{w}. If the amount of chain extender is increased from 5 to 8 wt %, Mₙ and M_{w} increase even further.
The polyester resins of Examples 1 and 2 were completely soluble in tetrahydrofuran (THF), which indicates that these two products do not contain gel, i.e. cross-linked product.

### EXAMPLES 3-5

For Examples 3-5, the same conditions applied as described for Example 1, except that polyester resin precursor B was used and that the amounts of chain extender and catalyst used were as indicated in Table 2.

The polyester resins of Examples 3-5 were analyzed using size exclusion chromatography (SEC) with polystyrene calibration in order to determine the molecular weight of the chain-extended polyester. The results are listed in Table 2.

TABLE 2

| | Amount of Chain | Amount of | | | |
|---|---|---|---|---|---|
| | extender | Catalyst | Mₙ | M_{w} | |
| No. | wt % | wt % | (g/mol) | (g/mol) | M_{w}/Mₙ |
| B | None | None | 9240 | 20700 | 2.24 |
| Exp. 3 | Epikote 828LV, 2.5% | 1 | 11900 | 36700 | 3.08 |
| Exp. 4 | Epikote 828LV 2.5% | 2 | 12700 | 45600 | 3.60 |
| Exp. 5 | Epikote 828LV, 5% | 2 | 12200 | 54100 | 4.42 |

The polyester resins of Examples 3-5 were completely soluble in tetrahydrofuran (THF), which indicates that these polyester resins do not contain gel, i.e. cross-linked product.

1. Process for preparing a polyester resin having a gel content of less than 0.45 wt %, based on the total weight of the polyester resin, and a glass transition temperature of between 40 and 70° C., comprising the step of reacting a polyester resin precursor with a chain extender which is different from the building blocks of the polyester precursor resin, optionally in the presence of a catalyst, at a temperature between 170 and 300° C. in a continuous reactor, wherein the polyester resin precursor comprises a functional group present as end group selected from hydroxyl or carboxyl, and optionally a functional group in the polyester resin precursor backbone selected from hydroxyl, carboxyl, amine, and carbonate, and the molar ratio of the functional group in the polyester resin precursor backbone to the functional group present as end group is at most 10:1.

2. A process according to claim 1 wherein the continuous reactor is an extruder.

3. A process according to claim 1 wherein the polyester resin does not contain any functional groups in the polyester resin precursor backbone.

4. A process according to claim 1 wherein the chain extender comprises two reactive groups.

5. A process according to claim 1 wherein the catalyst is a metallic soap.

6. Polyester resin having a gel content of less than 0.45 wt %, based on the total weight of the polyester resin, and a glass transition temperature of between 40 and 70° C., which is prepared from a polyester resin precursor and a chain extender which is different from the building blocks of the polyester precursor resin.

7. A polyester resin according to claim 6 wherein the polyester resin precursor comprises a functional group present as end group selected from hydroxyl or carboxyl, and optionally a functional group in the polyester resin precursor backbone selected from hydroxyl, carboxyl, amine, and carbonate, and the molar ratio of the functional group in the polyester resin precursor backbone to the functional group present as end group is at most 10:1.

8. A polyester resin according to claim 6 having a melt viscosity of at least 2.5 Pa·s at a temperature of 240° C. at a shear rate of 100 s⁻¹.

9. A polyester resin obtainable by the process of claim 1.

10. Block copolymer prepared from a polyester resin precursor, a second polyester resin precursor, and a chain extender which is different from the building blocks of the polyester precursor resin and/or the second polyester resin precursor.

11. Toner formulation comprising a polyester resin having a gel content of less than 0.45 wt %, based on the total weight of the polyester resin, and a glass transition temperature of between 40 and 70° C., which is prepared from a polyester resin precursor and a chain extender which is different from the building blocks of the polyester precursor resin.

12. Toner formulation comprising a block copolymer prepared from a polyester resin precursor, a second polyester resin precursor, and a chain extender which is different from the building blocks of the polyester precursor resin and/or the second polyester resin precursor.
